(19) United States
(12) Patent Application Publication
(10) Pub. No.: US 2006/0267787 A1
(43) Pub. Date: Nov. 30, 2006

(54) External antenna open circuit detection

(75) Inventors: Brian Marlett, Macomb, MI (US); Patricia Kachouh, Sterling Heights, MI (US); Josef Baumgartner, Voels (AT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/339,048

(22) Filed: Jan. 25, 2006

Related U.S. Application Data
(60) Provisional application No. 60/686,067, filed on May 27, 2005.

(51) Int. Cl. G08B 21/00

(52) U.S. Cl. 340/652

(57) ABSTRACT

A method of diagnosing an electronic connection open circuit includes measuring a received signal strength and determining the status of the electronic connection in response to the received signal strength. An open circuit fault signal is communicated where the received signal strength is below a desired signal strength. A user corrects the open circuit fault in response to the detection of an open circuit.

### CROSS REFERENCE TO RELATED APPLICATIONS

This application claims priority to U.S. Provisional Application No. 60/686,067, filed Mar. 27, 2005.

### BACKGROUND OF THE INVENTION

This invention generally relates to remote signal communication systems, and more particularly to a method of determining the status of an electronic connection of a vehicle.

A variety of remote signal communication systems are used in vehicles. Radio frequency (RF) signals have become a communication mode of choice in a number of systems of this type. Examples include remote keyless entry systems (RKE), passive entry and starting systems (PASE) and tire pressure monitoring systems for vehicles. Such systems typically include a handheld transmitter, such as a key fob or “smart card” that provides a signal to a receiver module located on the vehicle. The receiver module actuates a vehicle system in response to transmissions received from the key fob. The receiver module may unlock a vehicle door in response to transmissions received from the key fob where the system controlled by the key fob is an RKE system, for example.

One challenge facing designers of such systems is increasing the range in which the transmitter and the receiver module components satisfactorily operate. Typically, the receiver module is provided with an external antenna, such as an antenna encased in the rearview window of a vehicle, to increase the distance that the receiver module may effectively respond to transmissions emitted by the transmitter. External antennas are generally preferred over internal antennas because of their superior coverage capabilities (i.e. increased range). The external antenna must be connected to the receiver module to achieve the desired increase in operation range.

Disadvantageously, external antennas are not equipped with diagnostics to ensure that the antenna is properly connected to the receiver module. Therefore, a vehicle may be delivered to its end destination with an unconnected antenna. This may result in relatively poor RF performance of a remote signal communication system.

Accordingly, it is desirable to provide a method for detecting the status of an electronic connection of a remote signal communication system.

### SUMMARY OF THE INVENTION

An example method of diagnosing an open circuit of on electronic connection of a vehicle comprises measuring a received signal strength and determining the status of the electronic connection in response to the measured signal strength. In one example, an open circuit fault signal is communicated in response to the measured signal strength failing to meet a pre-defined threshold.

An example status indicator testing apparatus for detecting an external antenna open circuit includes a fixture, a transmitter and a receiver module. In one example, the fixture is localized to the vehicle to ensure a consistent and accurate testing procedure. The receiver module is operative to receive data from the transmitter and communicate an open circuit fault signal in response to the data received by the receiver module failing to meet a pre-defined threshold. In one example, the transmitter communicates with the receiver module through a remote keyless entry system. In another example, the transmitter communicates with the receiver module through a passive entry and starting system.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 schematically illustrates a remote signal communication system for a vehicle;

FIG. 2 schematically illustrates an open circuit status testing apparatus for detecting an external antenna open circuit according to this invention; and

FIG. 3 is a block diagram illustrating an example method of detecting an open circuit on a vehicle according to the present invention.

### DETAILED DESCRIPTION OF THE PREFERRED EMBODIMENTS

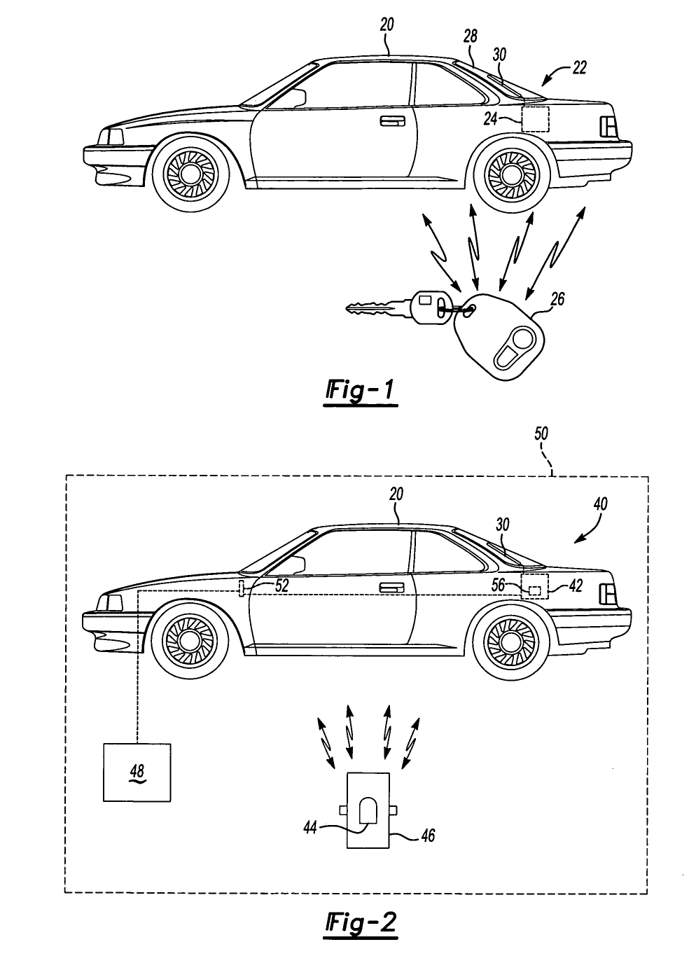

Referring to FIG. 1, a vehicle 20 includes a remote signal communication system 22. The remote signal communication system 22 may be any remote signal communication system known in the art, including but not limited to a remote keyless entry system (RKE), a passive entry and starting system (PASE) or a tire pressure monitoring system.

The remote signal communication system 22 includes a receiver module 24 and a transmitter 26. In one example, the transmitter 26 is a key fob. The receiver module 24 is preferably a radio frequency (RF) receiver such that the transmitter 26 communicates with the receiver module 24 by communicating RF signals. Although the remote signal communication system 22 is described in terms of RF signals, it should be understood that other communication mediums may be utilized according to the present invention.

The receiver module 24 is preferably mounted near the rear packing shelf of the vehicle 20, or between the rear seat and the rear windshield 28 of the vehicle 20. In another example, two receiver modules 24 are mounted near the rear packing shelf of the vehicle 20. The actual number of receiver modules 24 utilized within the remote signal communication system 22 and the actual location of the receiver modules 24 will vary depending upon application specific parameters such as the vehicle model and the number of remote signal communications systems the vehicle is equipped with.

An external antenna 30 is connected to the receiver module 24 by a connector assembly. The external antenna 30 provides a range of operation for which the receiver module 24 will receive RF signals from the transmitter 26. For example, a range of at least 60 meters may be achieved with the use of an external antenna 30. In one example, the external antenna 30 is substantially contained within the rear windshield 28. The external antenna 30 may be mounted to the vehicle 20 in any known manner. An external antenna provides superior range capabilities as compared to an internal antenna.

In response to data in the form of RF signals received from the transmitter 26, the receiver module 24 actuates a vehicle system. In one example, the receiver module may unlock a vehicle door where the system controlled by the transmitter 26 is a RKE system. In another example, the receiver module 24 may automatically start the engine of the vehicle where the system controlled by the transmitter 26 is a PASE system. It should be understood that any electronic vehicle system may be actuated by the receiver module 24 according to the present invention.

Referring to FIG. 2, an open circuit status testing apparatus 40 includes a fixture 46, an RF transmitter 44, a receiver module 42 and a testing tool 48 and is illustrated in a controlled testing environment 50. The testing apparatus 40 is utilized in a controlled environment to ensure a consistent testing environment that achieves greater consistency and accuracy in the detection of an external antenna 30 open circuit. Although the testing apparatus 40 described herein is shown and described in terms of external antenna 30 open circuit detection, it should be understood that the testing apparatus 40 may be used to detect an open circuit for any electronic connection located on the vehicle.

In one example, the testing apparatus 40 is utilized to perform an external antenna 30 open circuit status test at a vehicle manufacturing plant prior to shipment of the vehicle 20 to an automotive dealership for sale to an end user. In this way, an open circuit indicative of an unconnected external antenna 30 can easily be detected prior to the vehicles 20 exit from the manufacturing plant. Although the testing apparatus 40 disclosed herein is described for use within a vehicle manufacturing plant, it should be understood that other locations of use for the testing apparatus 40 are within the scope of this invention.

The fixture 46 of the testing apparatus 40 is localized to the vehicle 20. That is, the fixture 46 is located in an identical position and orientation relative to the vehicle 20 to ensure a consistent and accurate signal strength measurement for each vehicle undergoing testing. The transmitter 44 is at least partially positioned within the fixture 46 such that the transmitter is placed in an identical location relative to the vehicle 20 for each vehicle 20 being tested.

In one example, the transmitter 44 is a key fob identical to the key fob 26 illustrated in FIG. 1 and the receiver module 42 is identical to the receiver module 24 as illustrated in FIG. 1. The transmitter 44 and the receiver module 42 communicate data to one another using RF signals. Other known transmitters and receiver modules are also within the scope of the testing apparatus 40 of the present invention.

The receiver module 42 includes a controller 56. The controller 56 may be of any suitable microcontroller, microprocessor, computer or the like. The controller 56 of the receiver module 42 includes instructions for unlocking a vehicle door in response to RF transmissions communicated by an actuated transmitter 44 to the receiver module 42 where the system controlled by the transmitter 44 is an RKE system, for example.

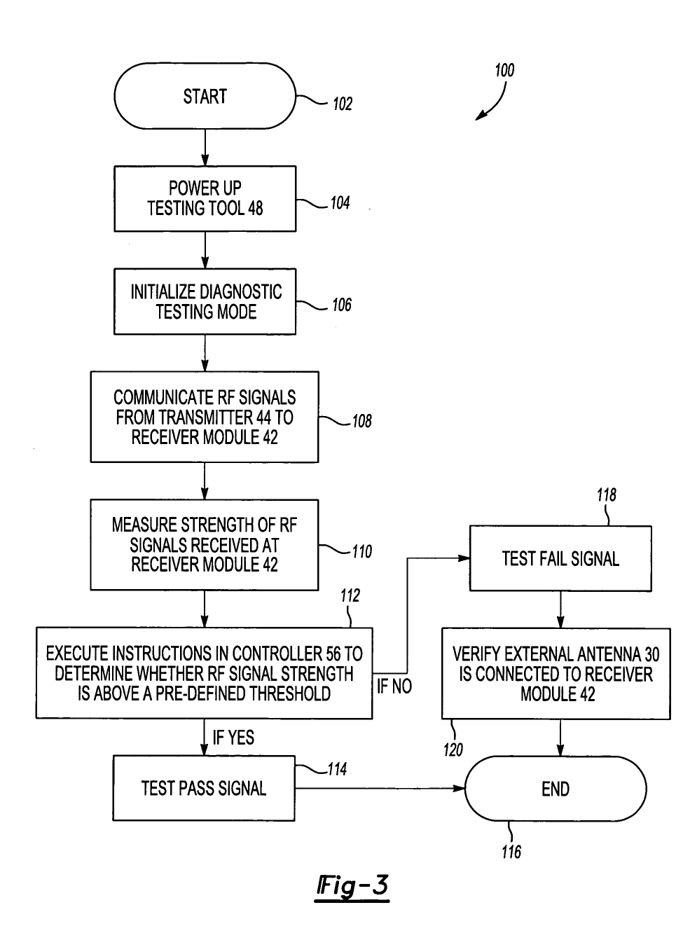

In one example, the performance characteristics of the transmitter 44 are known. The performance characteristics of the transmitter 44 are determined during the development of the communication system undergoing testing. The performance characteristics of the transmitter 44 must be known to enable the controller 56 of the receiver module 42 to determine whether signal strength received from the transmitter 44 is below a desired signal strength (i.e. a pre-defined threshold). If below the desired signal strength, an open circuit is considered true at the external antenna 30 connection and a user is informed of the unplugged connection, as is further discussed below with respect to FIG. 3.

A testing tool 48 is utilized to communicate with the receiver module 42 and receive an open circuit fault signal indicative of an unconnected external antenna 30. The testing tool 48 also communicates with the receiver module 42 to initialize a diagnostic test mode. In one example, the testing tool 48 is a lap top computer and is connected to the vehicle 20 through a vehicle communication bus 52. By connecting through the communication bus 52, the testing tool 48 is connected to and in communication with any electronic system located on the vehicle 20. It should be understood that other equipment may be utilized as the testing tool 48 of the present invention to communicate with receiver module 42.

Referring to FIG. 3, and with continuing reference to FIGS. 1 and 2, a method 100 for performing an external antenna 30 open circuit detection test is illustrated. The method 100 begins at start block 102 and power is applied to the testing tool 48 at block 104. The testing tool 48 communicates a signal through the communication bus 52 to the controller 56 of the receiver module 42 to initialize a diagnostic test mode at block 106.

Next, at block 108, the transmitter 44 communicates data through RF signals to the receiver module 42. In one example, a PASE function in utilized to communicate signals between the transmitter 44 and the receiver module 42. Where a PASE function is utilized, it is unnecessary for a user to manually actuate the transmitter 44 to communicate a signal to the receiver module 42. The transmitter 44 automatically communicates with the receiver module 42 when the transmitter 44 is located within a certain range of the receiver module 42 in a PASE system. In another example, a user may manually activate the transmitter 44 by depressing a button to communicate data to the receiver module 42. It should be understood that any remote signal communication system, including but not limited to PASE, RKE, tire pressure monitoring systems or any combination of these systems, may be utilized to initialize communication between the transmitter 44 and the receiver module 42.

The controller 56 of the receiver module 42 determines the strength of the received signals communicated thereto by the transmitter 44 at step 110. At step 112, the receiver module 42 executes instructions stored within the controller 56 for determining whether the received signal strength from the transmitter 44 is above or below a pre-defined threshold (i.e. the known performance characteristics of the transmitter 44). If the received signal strength is above the pre-defined threshold, the receiver module 42 communicates a test pass signal to the testing tool 48 indicative of an external antenna 30 closed circuit at step 114. The test is considered complete at step 116 where a passing indication is received at the testing tool.

If the signal strength received by the receiver module 42 is below the pre-defined threshold, the receiver module 42 communicates a test fail signal indicative of an external antenna 30 open circuit to the testing tool at step 118. Next, at step 120, the user performing the test verifies that the external antenna 30 is connected to the receiver module 42 of the vehicle 20. Once verification is completed at step 120, the method ends at step 114 where the testing cycle is considered complete and the testing apparatus is reset to prepare for performance of the open circuit test on subsequent vehicles.

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

We claim:

1. A method of diagnosing an open circuit of an electronic connection, comprising:
(a) measuring a received signal strength; and
(b) determining the status of the electronic connection in response to the received signal strength measured in said step (a).

2. The method as recited in claim 1, wherein said step (b) further comprises:
communicating an open circuit fault signal responsive to the received signal strength measured in said step (a) failing to meet a desired signal strength.

3. The method as recited in claim 2, further comprising the step of:
(c) correcting the open circuit in response to the open circuit fault signal.

4. A method of determining the status of an external antenna connection on a vehicle, comprising the steps of:
(a) positioning a transmitter in a known proximity relative to the vehicle;
(b) activating a test mode of a receiver module;
(c) communicating a signal from the transmitter and receiving the signal at the receiver module; and
(d) determining whether the signal received at the receiver module meets a desired signal strength.

5. The method as recited in claim 4, further comprising the step of:
(e) communicating an open circuit fault signal responsive to the signal received at the receiver module failing to meet the desired signal strength.

6. The method as recited in claim 4, wherein said step (c) comprises:
communicating the signal to the receiver module by actuating the transmitter.

7. The method as recited in claim 4, wherein said step (c) comprises:
communicating the signal to the receiver module through a passive entry and starting system.

8. The method as recited in claim 4, wherein said step (d) comprises:
correcting the external antenna connection in response to a failure of the signal received at the receiver module to meet the desired signal strength.

9. An status indicator testing apparatus for a vehicle, comprising:
a fixture positioned in a known proximity to said vehicle;
a transmitter at least partially positioned within said fixture; and
a receiver module having at least one external antenna, said receiver module being in communication with said transmitter and operative to receive a signal from said transmitter and communicate an open circuit fault signal in response to said signal failing to meet a desired signal strength.

10. The apparatus as recited in claim 9, wherein said signal received at said receiver module is communicated through a remote keyless entry system.

11. The apparatus as recited in claim 9, wherein said signal received at said receiver module is communicated through a passive entry and starting system.

12. The apparatus as recited in claim 9, wherein said signal comprises radio frequency transmission signals.

13. The apparatus as recited in claim 9, further comprising a testing tool, said testing tool operative to receive said open circuit fault signal from said receiver module and display an error indication for analysis by a user.

14. The apparatus as recited in claim 13, wherein said testing tool is operative to communicate with said receiver module to initialize a diagnostic test mode.

15. The apparatus as recited in claim 9, wherein said open circuit fault signal is indicative of an open circuit between said at least one external antenna and said receiver module.
